(19) United States
(12) Patent Application Publication
(10) Pub. No.: US 2002/0169962 A1
(43) Pub. Date: Nov. 14, 2002

(54) Digital watermarks used in automation equipment

(76) Inventor: Trent J. Brundage, Sherwood, OR (US)

Correspondence Address: ELMER GALBI, 13314 VERMEER DRIVE, LAKE OSWEGO, OR, 97035

(21) Appl. No.: 09/854,408

(22) Filed: May 10, 2001

(51) Int. Cl. G09C 3/00

(52) U.S. Cl. 713/176

(57) ABSTRACT

An automation system that can detect and read digital watermarks in order to facilitate control of automation equipment such as pick and place machines or material handling robots. An image containing a digital watermark is printed on (or otherwise attached to) an item. The item can be a part such as an electronic component or it may be some other type of object. The image containing the digital watermark is printed or attached to the item at a particular location on the item and with a pre-determined orientation relative to the item. A machine vision system (i.e. a camera) is used to acquire a digital image of the item including an electronic version of the printed image that is attached to the item. The digital watermark can include an orientation or grid signal and a data payload signal. The grid signal can be used to determine the orientation and location of the image, and hence, the orientation and location of the item. The data payload can be used to Garry any desired digital data. The ability to detect and read digital watermarks gives an automation system advantages over prior automation systems.

### FIELD OF THE INVENTION

The present invention relates to automation equipment and more particularly to automation equipment that utilizes machine vision equipment.

### BACKGROUND OF THE INVENTION

Automation technology is well developed and in wide use. Robots that perform repetitive tasks are common in many factories. Machine vision, that is, the ability of a machine to visually perceive information is a key to advanced automation systems. There is a large body of technical literature and patents devoted to automation equipment and to machine vision systems.

The known machine vision systems can perceive the shape of an item or part, read a bar code, detect various marks (which for example identify a location), detect color, detect particular shapes, and in some advanced situations read numbers or text.

Machine visions systems are often used in systems which grasp a part or item and place the part or item at a certain location (i.e. pick and place system). The machine visions systems in “pick and place” systems are often designed to capture a two dimensional image of a physical object and analyze the image to locate the position of certain features in the image. The location of these features is then used to determine the alignment of the physical object. The pick and place mechanical equipment then moves the object to a desired location and the object is oriented in accordance with data provided by the machine vision system.

Many prior art machine vision systems use template matching techniques. In a template matching technique a stored image (referred to as a template) is iteratively compared with an acquired image to determine the orientation and/or position of features in the acquired image.

The present invention provides a new system and method whereby a machine vision system can determine the location and orientation of an object using data from a digital watermark.

### SUMMARY OF THE PRESENT INVENTION

The present invention provides an automation system that can detect and read digital watermarks in order to facilitate control of automation equipment such as pick and place machines or material handling robots. With the present invention an image containing a digital watermark is printed on (or otherwise attached to) an item. The item can be a part such as an electronic component or it may be some other type of object. The image containing the digital watermark is printed or attached to the item at a particular location on the item and with a predetermined orientation relative to the item. A machine vision system (i.e. a camera) is used to acquire a digital image of the item including an electronic version of the printed image that is attached to the item. The digital watermark can include an orientation or grid signal and a data payload. The grid signal can be used to determine the orientation and location of the image, and hence, the orientation and location of the item. The data payload can be used to carry any desired digital data. The ability to detect and read digital watermarks gives an automation system advantages over prior automation systems.

### BRIEF DESCRIPTION OF FIGURES

FIG. 1 is an overall block diagram of a first embodiment of the present invention.

FIG. 2 is a diagram of a circuit board with an image that contains a watermark.

FIG. 3 is a diagram illustrating the tiles in a watermarked image.

FIG. 4A, 4B and 4C are diagrams of a watermark grid signal in the Frequency plane.

FIG. 5 is a block diagram of the operation of the present invention.

### DETAILED DESCRIPTION

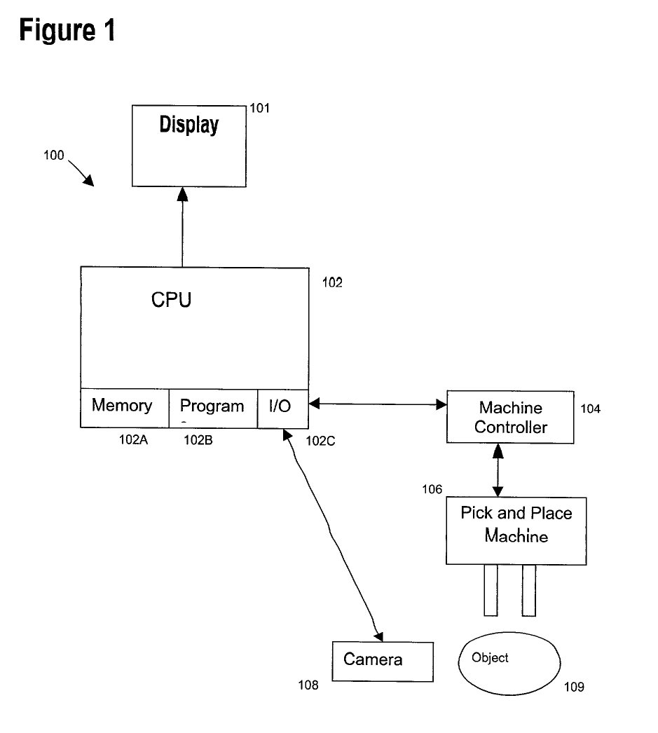

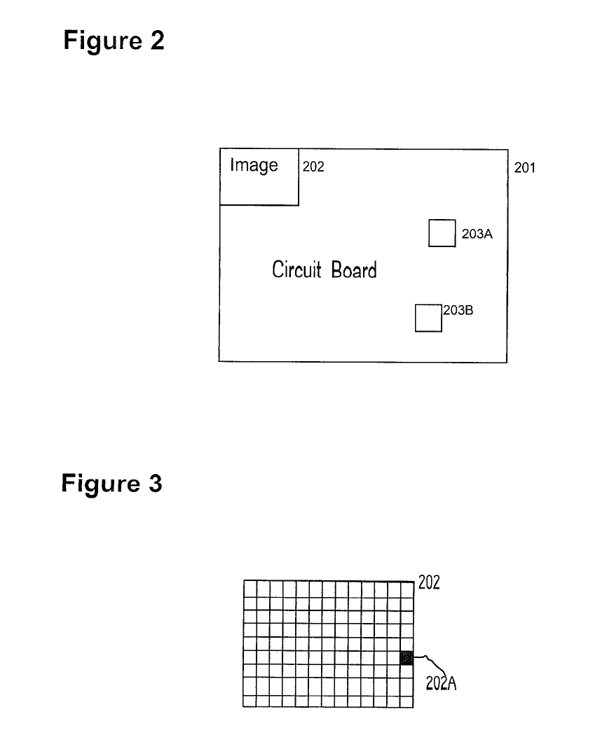

Pick and place machines, sometimes called robots, are widely used in manufacturing plants for a variety of automation applications. The first preferred embodiment of the invention described herein relates to the use of a pick and place machine to “pick” up electronic components and to “place” them on a circuit board. An overall block diagram of a first preferred embodiment of the present invention is given in FIG. 1. In the system shown in FIG. 1, a watermark on a part or object 109 is used to help control a “pick and place” machine 106. An example of object 109 is shown in more detail in FIG. 2.

The watermark on part 109 is detected and read by a camera 108. Camera 108 is a conventional digital camera of the type often used in machine vision systems. Camera 108 is mounted in a fixed position and the location and orientation of camera 108 is known to computer system 100.

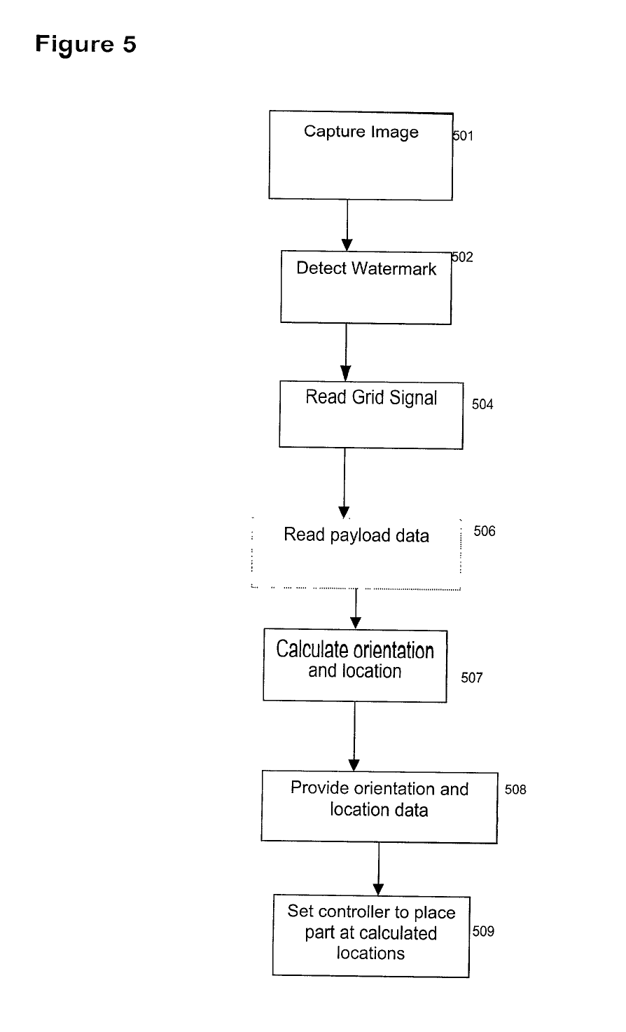

Camera 108 and machine controller 104 are connected to a computer 100 in a conventional manner. The pick and place machine 106 includes a conventional machine controller 104. The computer 100 includes a CPU 102, a display 100, memory 102A, and I/O controls 102C all of which are conventional. The computer 102B also includes a conventional operating system and other programs 102B to operate the machine tool controller 104. A block diagram of the programs that perform the operations peculiar to the present invention is given in FIG. 5.

The present invention is directed to detecting the orientation and exact location of object 109, so that the pick and place machine 106 can appropriately place a part at a particular location on object 109. The watermarked image acquired by camera 108 is processed by a watermark detection and reading program. The watermark reading program detects the grid signal and from the grid signal the orientation and location of the object can be determined.

In many watermark reading programs the grid signal is used to determine if the image has been enlarge or reduced, that is, the grid signal is used to determine image scale With the present invention, it is known that the scale of the image on the part 201 has not been changed, hence, the “scale” of the watermark grid signal can be used to calculate the distance from the camera (which is at a fixed position) to the part 201. This distance gives the location of the part 201.

FIG. 2 shows a specific example of object 109. The object shown in FIG. 2 is a circuit board 201. In the first preferred embodiment the pick and place machine 106 is used to place parts at location 203A and 203B of the circuit board 201. With the present invention circuit board 201 includes a printed image 202. Image 202 includes a digital watermark that can be similar to those described in the hereinafter referenced patents. Of particular importance to the present invention is the fact that the watermark contains a grid signal. The location and axis (i.e. orientation) of camera 108 is known and when camera 108 acquires a digital image of printed image 202, the system can determine from the grid signal the orientation and exact location of the circuit board.

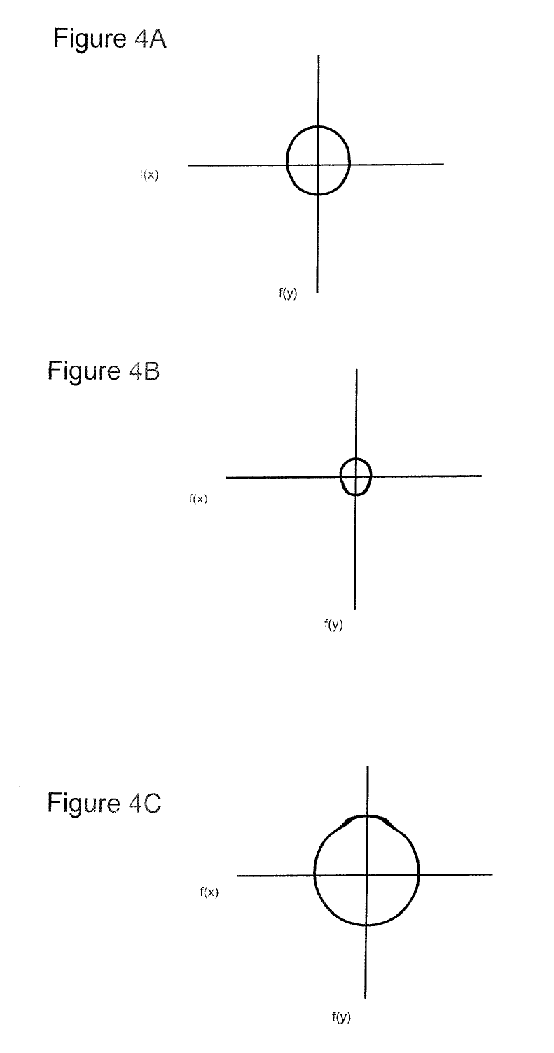

FIG. 4A shows a map in the frequency plane of a simple grid signal. That is, the luminance of the pixels in an image are changed by a signal that can be represented in the frequency plane as shown in FIG. 4A. The particular grid signal illustrated is a grid signal that in the frequency plane can be represented by a circle. Given that the position of camera 108 is fixed and known, if the object 109 is at a particular distance (designated x) from camera 108 when the grid signal from a watermark on part 109 is examined, the grid signal will appear in the frequency plane as illustrated in FIG. 4A. If the part is farther from the camera than the distance x, when the grid signal is examined, the circle in the frequency plane will be smaller as illustrated in FIG. 4B. If the part is closer to the camera than the distance x, when the grid signal is examined the circle in the frequency plane will be larger as illustrated in FIG. 4C. The simple grid signal shown in FIGS. 4A to 4C is useful to detect distance but it can not be used to detect orientation. If the signal in the frequency plane had characteristics that were not symmetrical, the rotational location of these characteristics would indicate the orientation of the part. For example, there could merely be a discontinuity in the circle. That is, the grid signal when viewed in the frequency plane would have a discontinuity at a particular location. When an image of the grid signal is acquired, by examining the location of this discontinuity, (i.e. the location in the frequency plane) one could determine the orientation of the part.

It should be understood that the grid signal described above is a very simple grid signal that did not take into consideration effects on the visual appearance of the image. More complex grid signals such as, for example, those used in commercial watermarking program could be used for this same purpose.

It is important to note that the watermark in image 202 is redundantly coded. This is illustrated in FIG. 3. As is conventional the watermark consists of a number of tiles. Each tile includes the entire watermark. Thus if the image is slightly damaged or covered, the system can still read the watermark.

While the particular embodiment described above includes an image on the circuit board 201, in alternate embodiments, the image can be on the parts picked up by the pick and place machine, In such a case the grid signal in the watermark can be used to convey to the computer 100, the machine the exact orientation of the part picked up by the pick and place machine 109. The pick and place machine can then be directed to move and rotate the part to the desired orientation and location.

The watermark can include payload data that provides other information. For example the grid signal on the watermark can be used to tell the system the orientation of a part and the payload data in the watermark can be a serial number of part number that insures that the correct part has been placed on the circuit board. In other embodiments, the payload data in the watermark can be used to record the serial number of the exact part placed on a particular circuit board.

In general the present invention provides another source of information for a pick and place machine or for a robot. This source of information is data obtained when camera 108 reads a watermark. The data in the watermark can include a grid signal that gives orientation and location and a payload signal that can carry other digital data.

FIG. 5 gives a block diagram of the program in computer 100 which handles the data acquired from the watermark and which provides this data to the other conventional program in computer 100. As indicated by block 501, the first step is the acquisition of a digital image of the printed image that contains a digital watermark. As indicated by block 502, the watermark in the image is detected. It is noted that as described in the prior art, reading a watermark generally involves first detecting the watermark and next reading data from the watermark. As indicated by block 504, the grid signal is extracted or read from the watermark. This can be done using the techniques described in the here in after referenced issued patents. If the watermark contains payload data, in addition to the grid signal, the payload data is read and provided to the other appropriate programs as indicated by the dotted box 506.

The orientation and exact location of the printed image and hence of the part on which the image is printed, can be calculated from the grid signal. As indicated by block 507, the orientation and if appropriate the location of the part 109 is calculated from the watermark grid signal. It is noted that the location of camera 108 is known, and the scale (i.e. size) of image 202 is known. In many watermark reading programs, the scale of the grid signal is used to determine if an image has been enlarged or reduced. In this case the scale factor is used to determine distance or location of the image since actual size of the image and location of the camera are known. Next as indicated by block 508, the orientation and location data is provided to the program that controls the pick and place machine. Finally an indicated by block 509, the control data is sent to controller 104 so that the machine 106 can appropriately orient and place the part.

Pick and place machines are known in the art. The details of the pick and place machine 106 forms no part of the present invention. Various Pick and place machines are for example described in U.S. Pat. No.: 6,174,171 entitled “Electrical connector with pick-and-place member”; U.S. Pat. No. 5,925,835 entitled “Method of and apparatus for testing a nozzle of a pick-and-place system”: U.S. Pat. No. 5,865,487 entitled “Pick-and-place tool for vacuum and magnetic coupling; U.S. Pat. No. 5,613,632 entitled “Manufacturing solder-perform holders for a pick-and-place machine; U.S. Pat. No. 5,524,947 entitled “Self-contained pick-and-place apparatus; U.S. Pat. No. 5,482,198 entitled “solder perform pick-and-place machine and operation; U.S. Pat. No. 5,449,265 entitled “Feeder and method of supplying a continuous strip of surface mount contacts to pick-and-place machine; U.S. Pat. No. 5,421,697 entitled “Telescopic pick-and-place robotic mechanism; U.S. Pat. No. 5,345,831 entitled “Drive for linear pick-and-place assembly apparatus; U.S. Pat. No. 5,247,844 entitled “Semiconductor pick-and-place machine calibration apparatus; U.S. Pat. No. 5,237,622 entitled “Semiconductor pick-and-place machine automatic calibration apparatus; U.S. Pat. No. 4,860,438 entitled “Surface mounting device pick-and-place head; U.S. Pat. No. 4,696,715 entitled “Pick-and-place glue applicator; U.S. Pat. No. 4,601,382 entitled “Pick-station and feed apparatus in pick-and-place machine; U.S. Pat. No. 4,564,326 entitled “Feed arrangement for pick-and-place machine; U.S. Pat. No. 4,453,882 entitled “Longreach linear pick-and-place assembly apparatus; and U.S. Pat. No. 4,503,907 entitled “Cam-driven rotary pick-and-place assembly apparatus the content of which are hereby incorporated herein by reference.

The present invention utilizes watermarking technology that was developed for other purposes. While if desired the present invention can use a grid signal particularly adapted to the present application, the type of grid signal used in other watermarking applications can also be used. For example, the image editing program “Adobe Photoshop” marketed by the Adobe Corporation has the ability to embed watermarks in images and the ability to detect and read watermarks that include a grid signal. Watermarking technology that can be used by the present invention is described among other places in: issued U.S. Pat. No. 5,748,783 issued May 5, 1998 and entitled “Method and Apparatus for Robust information Coding” which describes how quasi-rotational symmetry can be employed to facilitate detection of a signal notwithstanding rotation of the encoded signal; issued U.S. Pat. No. 5,809,160 entitled “Method for Encoding Auxiliary Data Within a Source Signal” which describes how a watermark signal can be redundantly encoded in an image; and issued U.S. Pat. No. 5,822,436 which describes the use of rotationally symmetric patterns. The description is the above patents is hereby incorporated herein by reference. Programs that watermark and detect watermarks in images are also commercially available

Camera equipment that has the ability to detect and read both a watermark grid signal and a watermark payload signal is well known. That is, systems and cameras which can acquire a digital watermarked image from a watermarked printed image are conventional. For example see co-pending application Ser. No. 09/444,770 filed Nov. 22, 1999 entitled “Adjusting an Electronic Camera to Acquire a Watermarked Image”; co-pending application Ser. No. 09/314,648, and co-pending application Ser. No. 09/343,104, the content of all of which is hereby incorporated herein by reference.

The system described above uses the location and orientation data to control the pick and place machine so that the part is oriented correctly and placed at the correct location. If the watermark includes other payload data, this other data is also provided to the system for various quality control and reporting purposes.

The first preferred embodiment described above relates to a pick and place machine for electronic components. The invention can be similarly applied to other types of automation equipment. For example the equipment can be used to provide information to a robot that picks up boxes. The grid signal in a watermark on a box can tell the robot the distance from the robot to the box. Furthermore the payload data in the watermark can tell the robot the weight and content of the box. Different watermarks on different faces of a box can tell the robot how a particular box is oriented. The payload data together with other data stored in the robot can tell a robot where a box should be placed.

It should be understood that while the invention has been described with reference to preferred embodiments thereof, a wide variety of changes and alterations can be made without departing from the spirit and scope to the invention. The scope of applications invention is defined and limited only by the appended claims.

I claim:

1) A method for controlling placement of a first part on a second part comprising,
placing a printed image containing a digital watermark on at least one of said parts,
capturing a digital image of said printed image,
reading a grid signal contained in said digital watermark, and
determining the angular rotation of said part from said watermark grid signal.

2) The method of claim 1 including the step of reading other payload data from said watermark.

3) The method of claim 1 wherein said grid signal is used to determine the location of said part.

4) The method recited in claim 1 wherein said first part is an electronic component.

5) The method recited in claim 1 wherein said second part is a printed circuit board.

6) A system for controlling a pick and placement machine which places a first part on a second part and wherein at least one of said parts includes a printed image containing a watermark,
means for reading data from said digital watermark from said part, and
means for determining the orientation of said part from the data read from said watermark.

7) The system of claim 6 including means for reading other payload data from said watermark.

8) The system of claim 6 wherein said grid signal is used to determine the location of said part.

9) The system of claim 6 wherein said grid signal is used to determine the distance of said part from said means for reading.

10) The system of claim 6 wherein said first part is an electronic component.

11) The system of claim 6 wherein said second part is a printed circuit board.

12) A robot for handling items, said robot including,
a camera for acquiring an electronic image of a printed image containing a watermark
a computer including a program from reading a digital watermark in an electronic image acquired by said camera,
a controller for controlling said robot in response to the data acquired from said digital watermark.

13) The robot recited in claim 12 including means for reading a grid signal from said digital watermark.

14) The robot recited in claim 13 wherein said printed image is on an item to be handled by said robot.

15) The robot recited in claim 14 including means for determining the distance from said camera to said item from said grid signal.

16) The robot recited in claim 14 including means for determining the orientation of said item from said grid signal.
